(19) United States
(12) Patent Application Publication
(10) Pub. No.: US 2003/0058470 A1
(43) Pub. Date: Mar. 27, 2003

(54) Multifunctional machine

(75) Inventor: Masanori Kamata, Tokyo (JP)

Correspondence Address: GREENBLUM & BERNSTEIN, P.L.C., 1950 ROLAND CLARKE PLACE, RESTON, VA, 20191, US

(73) Assignee: Matsushita Graphic Communication Systems, Inc., Tokyo (JP)

(21) Appl. No.: 10/245,689

(22) Filed: Sep. 18, 2002

(30) Foreign Application Priority Data
Sep. 26, 2001 (JP) 2001-295104

(51) Int. Cl. B41J 1/00; G06F 15/00

(52) U.S. Cl. 358/1.15

(57) ABSTRACT

A multifunctional machine is provided that includes a receiver that receives a binary communication image, an input section that inputs a copy image, and a recording section that records the communication image and the copy image. The multifunctional machine further includes a first processing section that performs image processing on the binary communication image for recording by the recording section, a second processing section that converts a binary copy image into a multilevel copy image, the second processing section performing image processing on the converted multilevel copy image for recording by the recording section, and a switching section that determines whether the binary communication data has a predetermined resolution. When the switching section determines that the binary communication image has the predetermined resolution, the second processing section further converts the binary communication image into a multilevel communication image and performs the image processing on the converted multilevel communication image.

### BACKGROUND OF THE INVENTION

1. Field of the Invention

This invention is related to a multifunctional machine having a communication function and a copy function.

2. Description of Related Art

Conventionally, there is a multifunctional machine that has a communication function and a copy function in a body of the machine. In this type of multifunctional machine, the communication function and the copy function share a physically common resource, such as a scanner and printer, etc., but have respective resources to control those functions.

The conventional multifunctional machine is explained with reference to FIG. 5 in the following. FIG. 5 is a block diagram illustrating a construction of a conventional multifunctional machine.

The conventional multifunctional machine 500 has a copy control section 501, which controls a copy function, a communication control section 502, which controls a communication function, and a recording section 503 commonly used by the copy control section 501 and the communication control section 502.

In the copy control section 501, a copy scanning controller 505 converts a multilevel copy image read by a scanning section 504 from a multilevel image into a binary image (referred as a “multilevel-binary conversion” in the following), and stores the converted binary image into a first memory section 506. Next, a copy recording controller 507 converts the copy image, which is stored in the first memory section 506, from the binary data into the multilevel data (referred as a “binary-multilevel conversion” in the following). The copy recording controller 507 then corrects the converted copy image by using recording correction coefficients corresponding to the characteristics of the recording section 503. Then, the recording section 503 records or prints the copy image that is image-processed as described above.

Meanwhile, in the communication controlling section 502, a communication controller 508 receives communication data transmitted through a line. Next, the communication command analyzer 509 analyzes the received communication data, sends a communication image to a second memory section 510, and sends a communication command to a communication recording controller 511. Then, the communication recording controller 511 corrects the binary communication image stored in the second memory section 510 by using recording correction coefficients (corresponding to the characteristics of the recording section 503). Then, the recording section 503 records or prints the communication image that is image-processed as described above.

As described above, the conventional multifunctional machine 500 performs different (separate) image processing on a copy image and a communication image.

The above-described conventional technology, however, has the following problems.

As described above, the conventional multifunctional machine equally processes all the received communication images as binary images. Consequently, even if the received communication image has a potential capability providing a high quality printed image, the actual image quality of printed communication image cannot be improved. Meanwhile, the multifunctional machine conventionally has an image processing function used for the copy image including binary-multilevel conversion, which provides a high quality printed image of the copy image, as described above.

### SUMMARY OF THE INVENTION

The present invention is provided in view of the above-described problems, and the objective of the present invention is to provide a multifunctional machine that improves the reproducibility of the communication image by selectively performing the binary-multilevel conversion on the communication image.

In an aspect of the present invention, the resolution of the received communication image is analyzed. When the resolution is higher than a predetermined resolution, the communication image is recorded (printed) after the binary-multilevel conversion.

Accordingly, since the binary-multilevel conversion can be selectively performed on the communication image having a high resolution, the reproducibility of the communication image can be securely improved.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a block diagram illustrating a construction of a multifunctional machine according to an embodiment of the present invention;

FIG. 2 is a block diagram to explain a recording operation of the multifunctional machine according to the embodiment of the present invention;

FIG. 3 is a flowchart illustrating a recording operation of a communication image by the multifunctional machine according to the embodiment of the present invention;

FIG. 4 is a flowchart illustrating a recording operation in accordance with a setting of a machine setting section, performed by the multifunctional machine according to the embodiment of the present invention; and

FIG. 5 is a block diagram illustrating a conventional multifunctional machine.

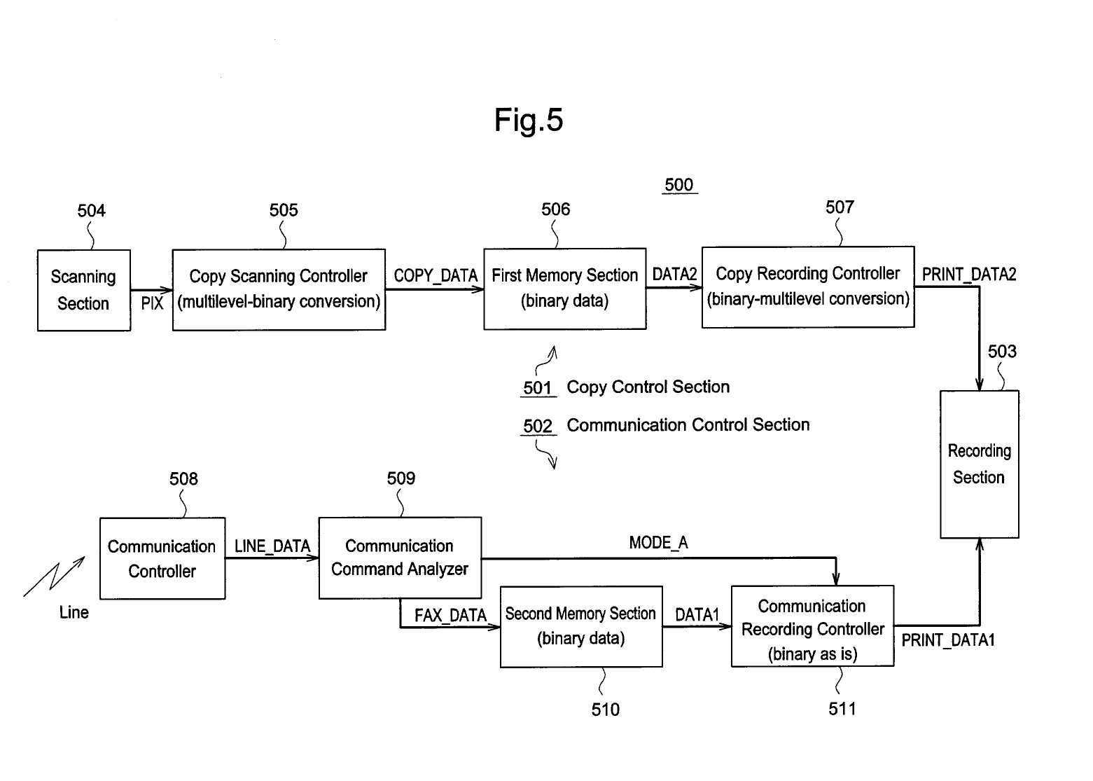

### DETAILED DESCRIPTION OF PREFERRED EMBODIMENTS

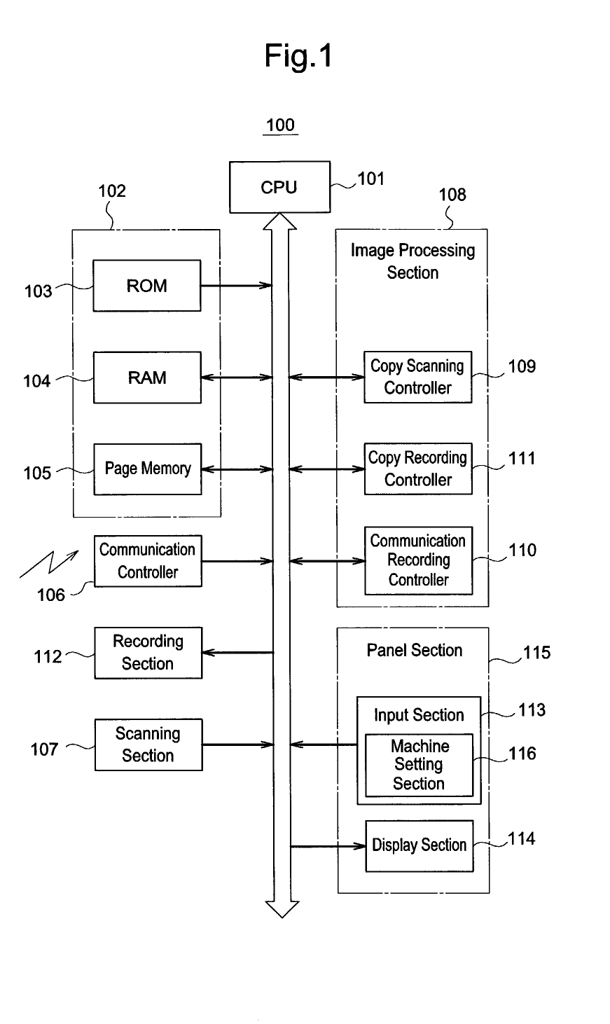

Embodiments of the multifunctional machine of the present invention are explained in the following, with reference to the drawings. First, a construction of a multifunctional machine of an embodiment is explained with reference to FIG. 1. FIG. 1 is a block diagram illustrating a construction of the multifunctional machine according to the embodiment of the present invention.

The multifunctional machine 100 has a CPU 101 that performs predetermined processes according to programs stored in a storage section (as means of storage).

The multifunctional machine 100 has a memory section 102 as the means of storage. The memory section 102 has a ROM (Read Only Memory) 103 that stores programs, which the CPU 101 downloads, and initialization information. Further, the memory section 102 has a RAM (Random Access Memory) 104, which is a work area into which the CPU 101 downloads the program stored in the ROM 103. The memory section 102 further has a page memory 105 that can store at least one page of image data by page as a unit.

The multifunctional machine 100 further has a communication controller 106 to perform communication through a line. The communication controller 106 is connected with another communication apparatus via the line, and performs transmission and reception of binary image data, a communication command, and the like, with another communication apparatus according to a communication procedure. The communication controller 106 sends the binary image data received from the line to the page memory 105.

The multifunctional machine 100 still has a scanning (reading) section 107 that scans (reads) image data from an original. The scanning section 107 outputs the optically read image data as analog data to an image processing section 108.

The image processing section 108 has a copy scanning controller 109 that converts the analog image data output by the scanning section 107 into multilevel digital image data and that further performs multilevel-binary conversion on the converted multilevel digital image data. The copy scanning controller 109 then sends the converted binary image data to the page memory 105. The copy scanning controller 109 performs multilevel-binary conversion by using an ordinary or conventional method, such as an error distribution method, a dither method, or the like.

The image processing section 108 further has a communication recording controller 110 that performs image-processing for recording, such as resolution conversion, on binary image data stored in the page memory 105, and that outputs the processed image. The communication recording controller 110 corrects the binary image data by using correction coefficients corresponding to the characteristics of the recording section 112 as a means of record. Thus, the recording section 112 can record (or print) the binary image data output by the communication recording controller 110 with a high quality.

The image processing section 108 further has a copy recording controller 111 that performs binary-multilevel conversion on the binary image data, which is once converted by using the error distribution method, the dither method, or the like, and is stored in the page memory 105, and that outputs image data after application of image-processing for recording. The copy recording controller 111 corrects the multilevel image data by using correction coefficients corresponding to the characteristics of the recording section 112. Thus, the recording section 112 can record (or print) the multilevel image data output from the copy recording controller 111 with a high quality.

The correction coefficients for recording are different based upon whether an image is binary or multilevel. In other words, the correction coefficients used by the communication recording controller 110 are different from the correction coefficients used by the copy recording controller 111. These correction coefficients are determined in advance and stored in the ROM 103. The communication recording controller 110 and the copy recording controller 111 read the correction coefficients stored in the ROM 103 and stores them in a memory (not shown) in the image processing section 108, to use them.

When the image data read by the scanning section 107 of the multifunctional machine 100 is transmitted to another communication apparatus, the copy scanning controller 109 converts the image data scanned (read) by the scanning section 107 into binary data and stores the converted binary data into the page memory 105. Then the communication controller 106 transmits the image data stored in the page memory 105 to another communication apparatus via a line.

The multifunctional machine 100 further has a panel section 115. The panel section 115 includes an input section 113 configured to input a variety of information and a variety of commands, such as a scanning operation start command, a storing operation start command, a communication start command, and the like, and a display section 114 configured to display the information input through the input section 113 and a status of the machine, and the like. The input section 113 further includes a machine setting section 116 configured to input a variety of settings regarding the multifunctional machine 100.

In the present embodiment, the copy recording controller 111 further converts the binary communication data into multilevel communication data to improve the quality of the printed image of communication data. However, the binary multilevel conversion of the communication data does not always provide better image quality. For example, when the resolution of the communication image is low, the binary-multilevel conversion can sometimes deteriorate the image quality. Accordingly, in the embodiment of the present invention, the resolution of the received communication image is analyzed. When the resolution is equal to or higher than a predetermined resolution, the binary-multilevel conversion is performed on the communication image.

Further, in the present embodiment, the resolution analysis is performed by analyzing received communication commands. A communication command analyzing section, which analyzes the communication commands, is realized by the CPU 101 performing corresponding (appropriate) programs.

In the present embodiment, in order to selectively perform the binary-multilevel conversion on the communication image having a resolution higher than a predetermined resolution, when the communication image has a resolution equal to or higher than the predetermined resolution, the communication image is sent to the copy recording controller 111 to perform binary-multilevel conversion. On the other hand, when the communication image has a resolution lower than the predetermined resolution, the communication image is sent to the communication recording controller 110. An image signal switching section, which switches destinations to which the communication image is sent, is also realized by the CPU 101 performing corresponding (appropriate) programs.

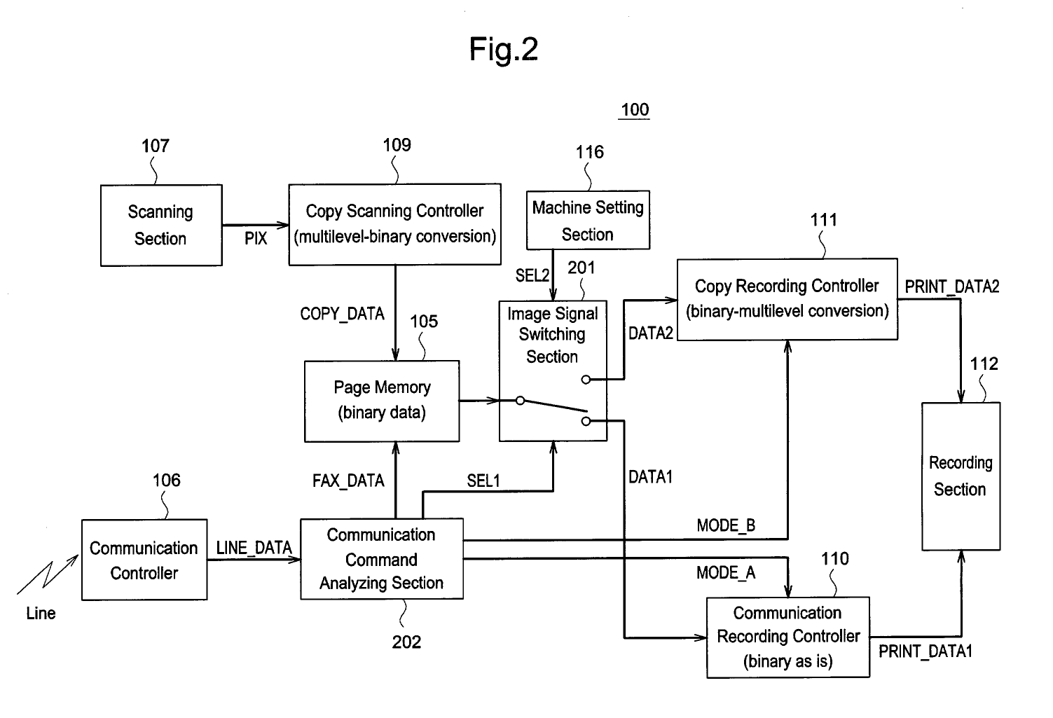

A recording operation (process) of the multifunctional machine 100 of the present embodiment is explained in the following with reference to FIG. 2. FIG. 2 is a block diagram illustrating the recording operation of the multifunctional machine according to the embodiment of the present invention.

Initially, an operation of the multifunctional machine 100 recording the image data (copy image) read by the scanning section 107 is explained. In the following explanation, the operations performed by the CPU 101 executing programs to realize the communication command analyzing section and the image signal switching section are simply explained as operations performed by the communication command analyzing section and the image signal switching section.

First, the scanning section 107 scans (reads) image data (copy image) of an original as analog data, and outputs the scanned data to the copy scanning controller 109. The copy scanning controller 109 converts the analog copy image data output from the scanning section 107 into multilevel digital copy image data, and further performs multilevel-binary conversion on the multilevel digital copy image data. Then, the copy scanning controller 109 outputs the converted binary copy image to the page memory 105. Thus, the copy image is temporarily stored in the page memory 105 as described above, because, when a plurality of identical copy images are printed, as a sort printing operation etc. does, the stored copy image can be repeatedly printed several times by referring to the page memory without scanning the same original repeatedly. In addition, the copy scanning controller 109 stores the copy data after the multilevel-binary conversion because the amount of data to be stored can be reduced.

Next, the multifunctional machine 100 sends the binary copy image stored in the page memory 105 to the image signal switching section 201. The copy image is image data having a high resolution enough to reproduce a high quality image even after a binary-multilevel conversion. Accordingly, the image signal switching section 201 sends the received copy image to the copy recording controller 111 to perform a binary-multilevel conversion.

Next, the copy recording controller 111 converts the binary image data stored in the page memory 105 into multilevel image data, performs image processing, such as a resolution conversion etc., on the converted multilevel image data by using correction coefficients for the multilevel image data, and outputs the image-processed copy image to the recording section 112. Then, the recording section 112 records (prints) the copy image.

Thus, the multifunctional machine 100 eventually records (prints) the copy image as the multilevel image data.

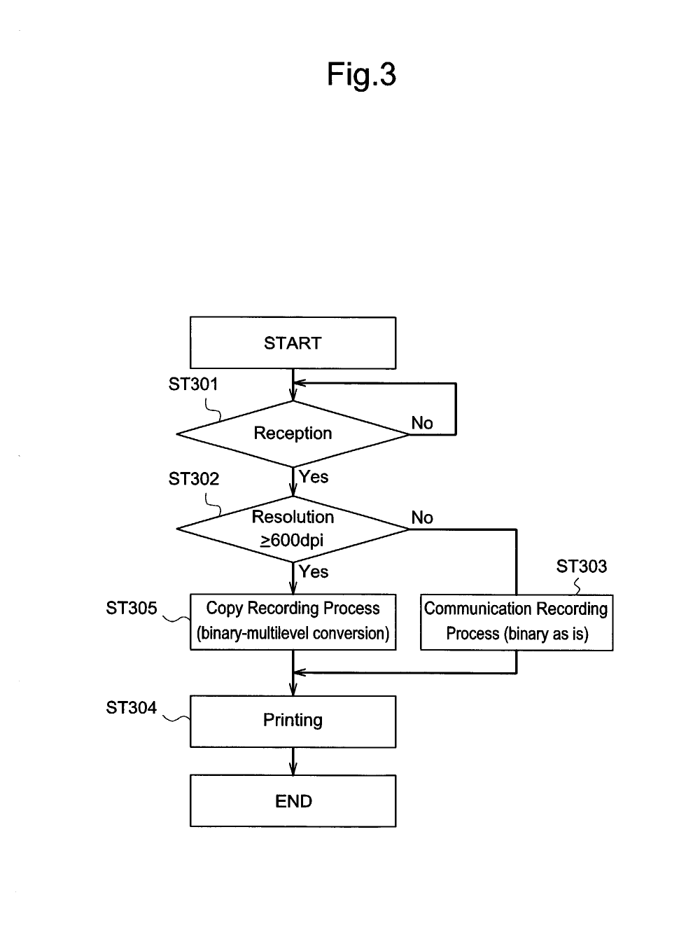

Next, an operation of the multifunctional machine 100 recording (printing) the image data (communication image) received by the communication controller 106 is explained with reference to FIG. 3 in addition to FIG. 2. FIG. 3 is a flowchart illustrating an operation when the multifunctional machine of the present embodiment records (prints) the communication image.

The communication controller 106 receives communication data from another communication terminal through a line (ST301), and sends the received communication data to the communication command analyzing section 202. The communication command analyzing section 202 analyzes the received communication data, decodes the communication image in the received communication data and stores the decoded communication image into the page memory 105, and sends resolution information included in the communication command of the received communication data to the image signal switching section 201, the communication recording controller 110 and the copy recording controller 111.

When a page of communication images is stored, the page memory 105 outputs the communication image to the image signal switching section 201.

Next, the image signal switching section 201 checks resolution data of the communication image received from the communication command analyzing section 202. In other words, the image signal switching section 201 determines whether the resolution of the received communication image is equal to or higher than the resolution with which the binary-multilevel conversion improves image quality (ST302). In this embodiment, the resolution with which the binary-multilevel conversion of the communication image improves the image quality is set 600 dpi, as an example.

Then, when the resolution of the communication image received from the page memory 105 is lower than the predetermined resolution 600 dpi, the image signal switching section 201 sends the communication image to the communication record controller 110 to process the communication data as binary data, because the binary-multilevel conversion of this communication image rather deteriorates the image quality. Then, the communication recording controller 110 performs image processing for recording, such as a resolution conversion, on the communication image having a resolution lower than 600 dpi, using correction coefficients for binary images, without performing the binary-multilevel conversion, and outputs the image-processed communication image to recording section 112 (ST 303). Then, the recording section 112 prints (records) the received binary communication image (ST 304), and the operation terminates.

On the other hand, when the resolution of the communication image received from the page memory 105 is equal to or higher than 600 dpi, the image quality of the communication image can be improved by the binary-multilevel conversion. Accordingly, the image signal switching section 201 sends the communication data to the copy recording controller 111 to perform a recording (printing) process after the conversion of the communication data from binary image data into multilevel data. Then, the copy recording controller 111 performs binary-multilevel conversion on the binary communication image. Further, the copy recording controller 111 performs image processing for recording, such as resolution conversion etc., on the converted multilevel image data by using correction coefficients for multilevel image data, and outputs the image-processed image data to the recording section 112 (ST 305). The recording section 112 prints the received multilevel communication image (ST 304), and the operation terminates.

As described above, when the received communication image has a predetermined resolution, the binary-multilevel conversion is performed on the communication image for printing. Thus, a high quality image can be obtained for a communication image as well as a copy image.

Because it is determined whether the received communication image has a resolution equal to or higher than the predetermined resolution, and the binary-multilevel conversion is selectively performed when the communication image has the resolution equal to or higher than the predetermined resolution, the communication image improves the image quality only when the image quality can be improved (cannot be deteriorated) by the binary-multilevel conversion. On the other hand, the communication image whose image quality is rather deteriorated by the binary-multilevel conversion, can avoid such deterioration of the image quality.

Further, because, ordinarily, the copy recording controller 111 for copy images can perform the binary-multilevel conversion of the communication image, an additional system for binary-multilevel conversion is not necessary to improve the quality of communication image. Thus, the construction of machine is not increased.

In addition, when the correction for recording is performed on the communication image after conversion, because the correction can be performed by using the existing correction coefficients, which are originally held by (prepared for) the copy recording controller 111, the high quality image can be obtained for the communication image as well as for the copy image, without preparing separate correction coefficients.

In this embodiment, the machine setting section 116 in the panel section 115 can be operated to switch between sending the communication image equally to the communication recording controller 110 to print the communication image as binary data, and sending the communication image having a high resolution to the copy recording section 111 to print the communication image after conversion from the binary data into the multilevel data. Thus, it is possible to respond to (satisfy) the user's needs which prefer to conventional binary images.

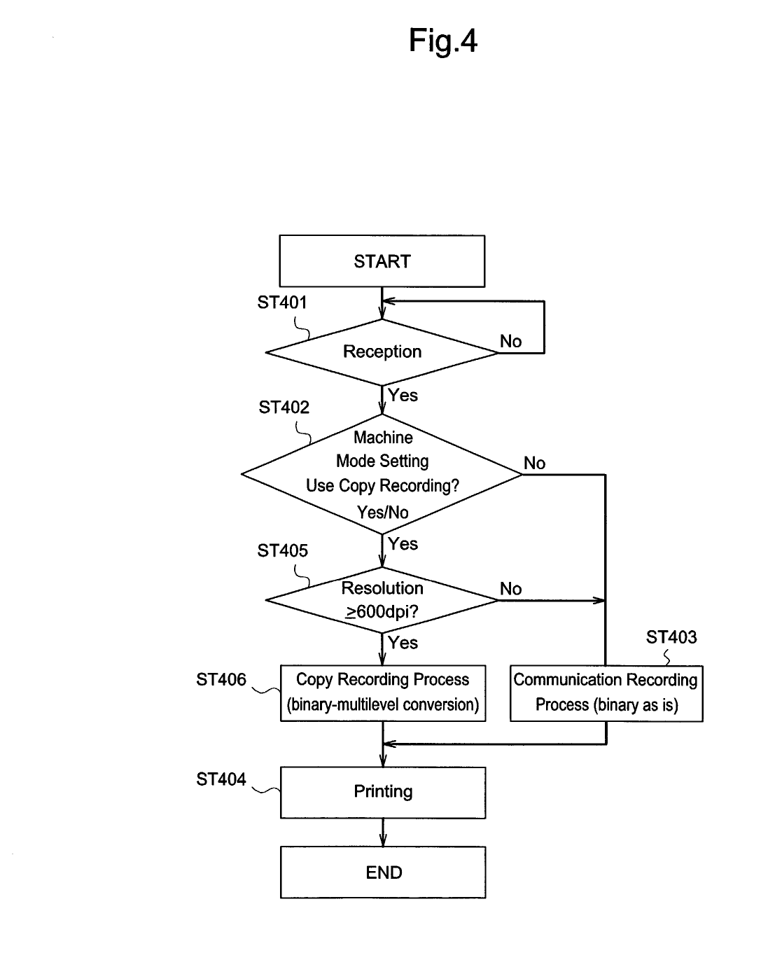

In the following, an operation of the multifunctional machine 100 recording the communication image received by the communication controller 106 based upon the setting by the machine setting section 116 is explained with reference to FIG. 4. FIG. 4 is a flowchart illustrating an operation of the multifunctional machine according to the embodiment of the present invention, when the communication image is recorded (printed) based upon the setting by the machine setting section.

The communication controller 106 receives communication data from another communication terminal through a line (ST 401), and sends the received communication data to the communication command analyzing section 202. The communication command analyzing section 202 analyzes the received communication data, decodes a communication image in the received communication data, stores the decoded communication image into the page memory 105, and sends resolution data included in the communication command of the communication data to the image signal switching section 201, the communication record controller 110 and the copy recording controller 111.

When a page of communication image is stored, the page memory 105 outputs the communication image to the image signal switching section 201.

The image signal switching section 201 checks the setting contents input from the machine setting section 116, and determines which of a first mode to record the communication image by the copy recording controller 111 according to the resolution or a second mode to record the communication image only by the communication record controller 110 is selected (ST 402).

When the mode is the second mode indicating that the communication image is recorded only by using the communication image controller 110, the communication image is sent to the communication recording controller 110 regardless of the resolution of the received communication image. Then, the communication recording controller 110 performs image processing for recording, such as resolution conversion etc., on the communication image by using the correction coefficients for binary images, without performing binary-multilevel conversion (ST 403). The image-processed communication image is output to the recording section 112. The recording section 112 prints the received binary communication image (ST 404), and the operation terminates.

On the other hand, when the mode is the first mode indicating that the communication image is recorded by using both the copy recording controller 111 and the communication recording controller 110, the image signal switching section 201 checks the resolution data of the communication image received from the communication command analyzing section 202, and determines whether the resolution of the received communication image is equal to or higher than the resolution (600 dpi) with which the image quality can be improved by the binary-multilevel conversion (ST 405).

When the communication image received from the page memory 105 has a resolution lower than the predetermined resolution 600 dpi, the image signal switching section 201 sends the communication image to the communication recording controller 110 to perform the recording process as binary data, because the binary-multilevel conversion rather deteriorates the image quality. The communication recording controller 110 performs the image processing for recording, such as resolution conversion etc., on the communication image having the resolution lower than 600 dpi without performing the binary-multilevel conversion, and outputs the image-processed communication image to the recording section 112 (ST 403). The recording section 112 prints the received binary communication image (ST 404), and the operation terminates.

On the other hand, when the resolution of the communication image received from the page memory 105 is equal to or higher than the predetermined resolution 600 dpi, the image signal switching section 201 sends the communication image to the copy recording controller 111 to perform the recording process after the binary-multilevel conversion. The copy recording controller 111 performs the binary-multilevel conversion on the binary communication image. Then, the copy recording controller 111 performs image processing for recording, such as resolution conversion etc., on the converted multilevel image data by using the correction coefficients for multilevel data, and outputs the image-processed communication image to the recording section 112 (ST 406). The recording section 112 prints the received multilevel communication image (ST 404), and the operation terminates.

As described above, the user's needs demanding the conventional binary image can be satisfied by setting the mode of the machine through the machine setting section 116 so as to perform a recording process on the communication image as binary data, instead of printing (copying) the communication images after binary-multilevel conversion.

In addition, even if the set mode indicates that the image processing is performed on the communication image by the copy recording controller 111, which is ordinarily used for copy images, when the communication image does not have the predetermined resolution, the image processing is performed on the binary communication image by the communication recording controller 110, which is ordinarily used for communication images. Accordingly, because the image processing is performed on the binary communication image when the image quality of the communication image is expected to be deteriorated by the binary-multilevel conversion, the multilevel communication image after the binary-multilevel conversion is prevented from having an image quality lower than that of the binary communication image on which the image-processing is performed.

In the above embodiment, the image signal switching section 201 and the communication command analyzing section 202 are implemented by the CPU 101 performing corresponding programs. However, the image signal switching section 201 and the communication command analyzing section 202 can be constructed as special purpose hardware.

Further, in the above-described embodiment, the copy scanning controller 109, the communication recording controller 110 and the copy recording controller 111 are implemented as hardware. However, alternatively, the CPU 101 can execute a program corresponding to the process performed by each of the copy scanning controller 109, the communication recording controller 110 and the copy recording controller 111.

In the above-described embodiment, the copy recording controller 111 and the communication recording controller 110 are respectively implemented as separate units of hardware. However, the copy recording controller 111 and the communication recording controller 110 can be implemented as one unit of hardware. Even in this implementation, if the correction coefficients for binary data and the correction coefficients for multilevel data are prepared in advance, and if both the communication image converted into multilevel data and the copy image are corrected by using the correction coefficients for multilevel data, preparation of additional correction coefficients to correct the communication image converted into the multilevel data is not required.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2001-295104 filed on Sep. 26, 2001, entire content of which is expressly incorporated by reference herein.

What is claimed is:

1. A multifunctional machine, comprising:
a receiver that receives a binary communication image;
a scanner that scans documents to obtain a copy image;
a printer that prints the binary communication image and the copy image;
a first processor that performs image processing on the binary communication image for printing by said printer;
a second processor that converts the copy image into a multilevel copy image, the second processor performing image processing on the converted multilevel copy image for printing by said printer;
a switching section that determines whether the binary communication data has a predetermined resolution; and
said second processor further converting the binary communication image into a multilevel communication image and performing the image processing on the converted multilevel communication image, when said switching section determines that the binary communication image has the predetermined resolution.

2. The multifunctional machine according to claim 1, wherein said scanner obtains an analog copy image,
the multifunctional machine further comprising a converter that converts the analog copy image into a binary copy image,
said second processor converting the binary copy image converted by said converter.

3. The multifunctional machine according to claim 1, wherein said switching section determines whether the binary communication data has a resolution higher than the predetermined resolution, and
said second processor converts the binary communication image into the multilevel communication image, when said switching section determines that the binary communication data has a resolution equal to or higher than the predetermined resolution. resolution.

4. A multifunctional machine, comprising:
a receiver that receives a binary communication image from the line;
a scanner that scans documents to obtain a copy image;
a printer that prints the communication image and the copy image;
a first processor that performs image processing on the binary communication image for printing by said printer;
a second processor that converts the copy image into a multilevel copy image, the second processor section performing image processing on the converted multilevel copy image for printing by said printer; and
a switching section that determines whether the binary communication data has a predetermined resolution;
wherein said first processor performs the image processing on the binary communication image, when said switching section determines that the resolution of the binary communication image is lower than the predetermined resolution, while said second processor converts the binary communication image into a multilevel communication image and performs the image processing on the converted multilevel communication image, instead of said first processor, when said switching section determines that the resolution of the binary communication image is equal to or higher than the predetermined resolution.

5. The multifunctional machine according to claim 1, wherein the predetermined resolution is 600 dpi.

6. A multifunctional machine, comprising:
a receiver that receives a binary communication image;
a scanner that scans documents to obtain a copy image;
a printer that prints the communication image and the copy image;
a first processor that is configured to perform image processing on the binary communication image for printing by said printer;
a second processor that converts the copy image into a multilevel copy image, said second processor performing image processing on the converted multilevel copy image for printing by said printer;
a setting section that selects one of a first mode to use said first processor for the binary communication image and a second mode to use said second processor for the binary communication image; and
said second processor further converting the binary communication image into a multilevel communication image and performing the image processing on the converted multilevel communication image, when said setting section selects the second mode.

7. A multifunctional machine, comprising:
a receiver that receives a binary communication image from a line;
a scanner that scans documents to obtain a copy image;
a printer that prints the communication image and the copy image;
a first processor that is configured to perform image processing on the binary communication image for printing by said printer;
a second processor that converts the copy image into a multilevel copy image, said second processor performing image processing on the converted multilevel copy image for printing by said printer;
a setting section that selects a first mode to use said first processor for the binary communication image when the resolution of the binary communication image is lower than the predetermined resolution, and selects a second mode to use said second processor instead of the first mode for the binary communication image when the resolution of the binary communication image is equal to or higher than the predetermined resolution.; and
said second processor further converting the binary communication image into a multilevel communication image and performing the image processing on the converted multilevel communication image, when said setting section selects the second mode for the binary communication image.

8. The multifunctional machine according to claim 6, further comprising a switching section that determines whether the binary communication image has a predetermined resolution,
wherein said first processor performs the image processing on the binary communication image when said switching section determines that the binary communication image has the predetermined resolution, even if said setting section selects the second mode.

9. The multifunctional machine according to claim 1, wherein said switching section determines whether the binary communication image has a resolution lower than a predetermined resolution, and
the first processor performs image processing on the binary communication data when said switching section determines that the binary communication image has the resolution lower than the predetermined resolution, even if said setting section selects the second mode.

10. A recording method using a multifunctional machine that records both a copy image read from an original and a communication image received via a line, the recording method comprising:
inputting a binary copy image;
converting the binary copy mage into a multilevel copy image;
performing image processing on the converted multilevel copy image for recording;
recording the image-processed multilevel copy image;
receiving a binary communication image;
determining whether the received binary communication image has a resolution lower than a predetermined resolution;
performing image processing on the received binary communication image when the determining determines that the received binary communication image has the resolution lower than the predetermined resolution;
recording the image-processed binary communication image when the determining determines that the received binary communication image has the resolution lower than the predetermined resolution;
converting the binary communication image into a multilevel communication image, when the determining determines that the received binary communication image does not have the resolution lower than the predetermined resolution;
performing image processing on the multilevel communication image when the determining determines that the received binary communication image does not have the resolution lower than the predetermined resolution; and
recording the image-processed multilevel communication image when the determining determines that the received binary communication image does not have the resolution lower than the predetermined resolution.

11. The recording method according to claim 10, wherein the converting the binary copy image into the multilevel copy image and the converting the binary communication image into the multilevel communication image are performed by an identical section in the multifunctional machine.

12. The recording method according to claim 10, wherein the inputting scans the original to obtain an analog copy image, the recording method further comprising converting the analog copy image into the binary copy image.

13. A recording method using a multifunctional machine that records both a copy image read from an original and a communication image received via a line, the recording method comprising:
inputting a binary copy image;
converting the binary copy mage into a multilevel copy image;
performing image processing on the converted multilevel copy image for recording;
recording the image-processed multilevel copy image;
setting one of a first mode and a second mode of the multifunctional machine;
receiving a binary communication image;
performing image processing on the received binary communication image when setting sets the first mode;
recording the image-processed binary communication image when the setting sets the first mode;
converting the binary communication image into a multilevel communication image, when the setting sets the second mode;
performing image processing on the multilevel communication image when the setting sets the second mode; and
recording the image-processed multilevel communication image when the setting sets the second mode.

14. The recording method according to claim 13, wherein the converting the binary copy image into the multilevel copy image and the converting the binary communication image into the multilevel communication image are performed by an identical section in the multifunctional machine.

15. The recording method according to claim 13, further comprising:
determining whether the received binary communication image has a resolution lower than a predetermined resolution;
performing image processing on the received binary communication data when the determining determines that the binary communication image has the resolution lower than the predetermined resolution, even if the setting sets the second mode.
